(19) United States
(12) Patent Application Publication
(10) Pub. No.: US 2024/0291138 A1
(43) Pub. Date: Aug. 29, 2024

(54) ANTENNA AND COMMUNICATION DEVICE

(71) Applicant: HUAWEI TECHNOLOGIES CO., LTD., Shenzhen (CN)

(72) Inventors: Wei Kang, Xi’an (CN); Chaochao Li, Xi’an (CN); Chunliang Xu, Xi’an (CN); Jiejun Zhou, Xi’an (CN)

(73) Assignee: HUAWEI TECHNOLOGIES CO., LTD., Shenzhen (CN)

(21) Appl. No.: 18/650,123

(22) Filed: Apr. 30, 2024

Related U.S. Application Data
(63) Continuation of application No. PCT/CN2022/120215, filed on Sep. 21, 2022.

(30) Foreign Application Priority Data
Nov. 18, 2021 (CN) 202111365994.3

(51) Int. Cl. H01Q 1/24; H01Q 15/14

(52) U.S. Cl. CPC H01Q 1/246; H01Q 15/14

(57) ABSTRACT

This disclosure provides an antenna. The antenna disclosure includes a reflective plate having a reflective surface, a mounting bracket, a feed network, and a radiating element. The mounting bracket is disposed on one side of the reflective surface, and the mounting bracket and the reflective surface form a cavity facing toward an exposure in a first direction. The feed network is disposed in the cavity. The feed network has a feed point, and a projection of the feed point is located in the exposure. The radiating element is disposed on the side of the reflective surface. A projection of the radiating element on the mounting bracket is located in the exposure, and the radiating element is coupled to the feed point. By the provided antenna disclosure material usage and an overall weight of the antenna can be reduced. This is conducive to improving communication quality of the antenna.

### CROSS-REFERENCE TO RELATED DISCLOSURES

This application is a continuation of International Application No. PCT/CN2022/120215, filed on Sep. 21, 2022, which claims priority to Chinese Patent Application No. 202111365994.3, filed on Nov. 18, 2021. The disclosures of the aforementioned applications are hereby incorporated by reference in their entireties.

### TECHNICAL FIELD

The disclosure relates to the field of communication technologies, and in particular, to an antenna and a communication device.

### BACKGROUND

Antennas are widely used in a plurality of different types of communication devices, and are configured to send or receive radio signals. For example, the antennas may be installed on signal towers (or poles) of base stations, so that signal sending and receiving capabilities, signal coverage, and the like of the antennas can be improved. During actual disclosure, an antenna weight determines difficulty of installing the antennas on the towers (or the poles). Specifically, the smaller the antenna weight, the easier it is to install the antennas on the towers, and the larger the antenna weight, the harder it is to install the antennas. In a current antenna, a large quantity of cable and solder connection manners are used. Consequently, a quantity of used cables and an amount of used solder are increased. This is not conducive to reducing the antenna weight. In addition, when the quantity of cables and a quantity of solder joints are increased, passive intermodulation is reduced and deteriorated, thereby affecting signal sending and receiving performance of the antenna. Therefore, during actual disclosure of the antenna, an antenna with a small weight, low costs, and good performance is always a work that needs to be continuously improved and perfected in the industry.

### SUMMARY

This disclosure provides an antenna and a communication device that can reduce material usage and an overall weight, and are conducive to improving performance.

According to an aspect, this disclosure provides an antenna. The antenna includes a reflective plate, a mounting bracket, a feed network, and a radiating element. The reflective plate has a reflective surface. The mounting bracket is disposed on one side of the reflective surface, and the mounting bracket and the reflective surface form a cavity facing toward an exposure in a first direction. The feed network is disposed in the cavity. The feed network has a feed point, and a projection of the feed point is located in the exposure. The radiating element is disposed on the side of the reflective surface, that is, the mounting bracket and the reflective surface are located on a same side of the reflective surface. A projection of the radiating element on the mounting bracket is located in the exposure, and the radiating element is coupled to the feed point.

In the antenna provided in this disclosure, both the feed network and the radiating element are disposed on a same side of the reflective surface, so that feeding can be performed between the feed network and the radiating element in a coupling manner. In addition, the mounting bracket and the reflective surface may jointly form the cavity having the exposure (or a semi-open exposure), to provide accommodation space for the feed network. Both the projection of the feed point of the feed network and the projection of the radiating element are located in the exposure, so that coupling between the feed network and the radiating element may be implemented. Alternatively, it may be understood that, in the antenna provided in this disclosure, the feed network and the radiating element are disposed on a same side of the reflective surface. Therefore, the feed network may feed the radiating element in a coupling manner, to avoid using an additional cable. Therefore, material usage and an overall weight of the antenna can be reduced. In addition, because the cable is omitted, or the feed network and the radiating element are coupled for feeding, a connection manner such as a solder connection, a screw connection, or a rivet connection may be avoided, so that introduction of an additional network loss can be avoided, and deterioration of passive intermodulation can be avoided. This is conducive to improving communication quality of the antenna.

In addition, in the antenna provided in this disclosure, because the feed network is disposed on the reflective surface of the reflective plate, more components for implementing other functions may be disposed on a back surface of the reflective plate (a surface away from the reflective surface). This is conducive to improving functionality and function density of the antenna.

In an implementation, the feed network may be fixedly connected to the mounting bracket, so that the feed network can be stably fastened in the cavity. That the feed network is disposed in the cavity means that a main body part of the feed network is located in the cavity. For the feed point of the feed network, because the feed point needs to feed the radiating element, the feed point may extend out of the cavity, to feed the radiating element. The feed point may extend out of the cavity, or may be located in the cavity, and is located in a projection range of the exposure.

In addition, that the feed network is fixedly connected to the mounting bracket may include that the feed network is fixedly connected to the mounting bracket through an insulated connecting piece, so that a conductive connection between the feed network and the mounting bracket can be avoided.

When the feed point is disposed, overlapping sizes of the projections of the feed point and the radiating element may be greater than or equal to ⅛ of an operating wavelength of the radiating element, and are less than or equal to ½ of the operating wavelength of the radiating element, so that the feed point can effectively feed the radiating element. The operating wavelength of the radiating element is a wavelength of an electromagnetic wave generated by the radiating element.

When the radiating elements are disposed, the radiating elements may be stacked on an outer side of the exposure. Alternatively, it may be understood that the projection of the radiating element is located in the exposure. Specifically, at least a part of the projection of the radiating element may be in the exposure. Alternatively, the entire projection of the radiating element is located in the exposure.

When the feed network is disposed, the feed network may include a feed strip, and one end of the feed strip may extend out of the exposure. The feed point may be located at the end that extends out of the exposure. For example, the feed strip may be a microstrip.

In addition, in specific embodiments, the mounting bracket may be made of a conductive material. When the feed network works normally, a generated electromagnetic signal may affect normal working of the radiating element. Therefore, after the mounting bracket is made of the conductive material, the mounting bracket can perform electromagnetic shielding on the feed network, to prevent the electromagnetic signal generated by the feed network from causing bad interference to the radiating element.

In specific embodiments, structures and compositions of the mounting bracket may be diversified, and several examples may be as follows:

For example, the mounting bracket may include a first frame body and a second frame body. The first frame body and the second frame body are disposed at a gap and in parallel. The first frame body, the second frame body, and the reflective surface form the cavity. The gap between the first frame body and the second frame body forms the exposure.

It may be understood that, during specific implementation, a distance between the first frame body and the second frame body may be flexibly adjusted based on an actual requirement, so that sizes of the cavity and the exposure may be changed. Alternatively, in some implementations, the first frame body and the second frame body may be disposed at an included angle, instead of being disposed in parallel. This is not limited in this disclosure.

In an implementation, there may be a plurality of radiating elements. Correspondingly, the feed network may include a plurality of feed points, and each radiating element is coupled to a corresponding feed point. Alternatively, it may be understood that the plurality of feed points may be disposed in the feed network, and each feed point may be coupled to the corresponding radiating element for feeding. In other words, the radiating element and the feed point may be disposed in a one-to-one manner, or may be disposed in a one-to-many manner.

In an implementation, the feed network may have a suspended strip, the suspended strip is disposed in the cavity, and there is a gap between the suspended strip and an inner wall of the cavity, so that conductive contact between the suspended strip and the inner wall of the cavity can be prevented.

The feed network may have a dielectric phase shifter. The dielectric phase shifter includes a first sliding medium and a second sliding medium, and the first sliding medium and the second sliding medium may be disposed on two sides of the suspended strip, and are slidably connected to the suspended strip.

In an implementation, the mounting bracket may be fixedly connected to the reflective plate through a conductive connecting piece. In this way, a fixed connection and a conductive connection between the mounting bracket and the reflective plate may be implemented. Alternatively, the mounting bracket may be fixedly connected to the reflective plate through an insulated connecting piece. This may be conducive to reducing the antenna weight through the insulated connecting piece. In addition, an electric connection between the mounting bracket and the reflective plate may alternatively be implemented in a coupling manner.

In an implementation, the antenna may further include a radome, and the reflective plate, the mounting bracket, the feed network, and the radiating element may all be located in the radome. An effective protection function may be provided for the reflective plate, the mounting bracket, the feed network, and the radiating element through the radome, and sending of an electromagnetic signal by the radiating element to the outside is not affected, or an external electromagnetic signal may be received by the radiating element through the radome.

According to another aspect, this disclosure further provides a communication device. The communication device includes any one of the foregoing antennas. In specific embodiments, the communication device may be a base station, radar, or the like. A type of the communication device is not limited in this disclosure.

### BRIEF DESCRIPTION OF DRAWINGS

FIG. 1 is a diagram of an example scenario of an antenna according to an embodiment of this disclosure;

FIG. 2 is a diagram of a structure of a base station according to an embodiment of this disclosure;

FIG. 3 is a block diagram of a structure of an antenna according to an embodiment of this disclosure;

FIG. 4 is a brief diagram of a structure of an antenna according to an embodiment of this disclosure;

FIG. 5 is a diagram of a structure of an antenna according to an embodiment of this disclosure;

FIG. 6 is a diagram of a partial structure of an antenna according to an embodiment of this disclosure;

FIG. 7 is a diagram of a cross-sectional structure of an antenna according to an embodiment of this disclosure;

FIG. 8 is another top view of a mounting bracket and a reflective plate according to an embodiment of this disclosure;

FIG. 9 is another top view of a mounting bracket and a reflective plate according to an embodiment of this disclosure;

FIG. 10 is a top view of an antenna according to an embodiment of this disclosure; and

FIG. 11 is a diagram of a partial structure of a feed network according to an embodiment of this disclosure.

### DESCRIPTION OF EMBODIMENTS

To make objectives, technical solutions, and advantages of this disclosure clearer, the following further describes certain embodiments in detail with reference to the accompanying drawings.

An antenna provided in embodiments of this disclosure may be used in a communication device such as a base station or radar, to implement a wireless communication function.

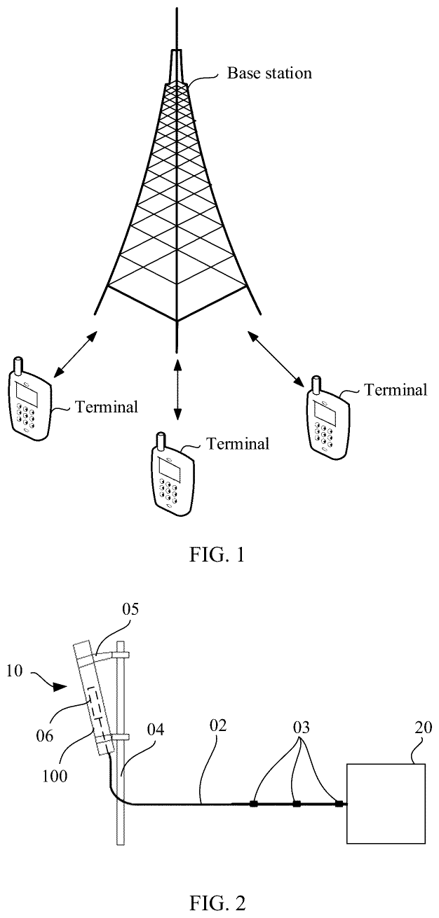

As shown in FIG. 1, an example scenario may include a base station and a terminal. Wireless communication may be implemented between the base station and the terminal. The base station may be located in a base station subsystem (BBS), a UMTS terrestrial radio access network (UTRAN), or an evolved universal terrestrial radio access network (E-UTRAN), and is configured to perform cell coverage of a radio signal, to implement communication between the terminal device and a wireless network. Specifically, the base station may be a base transceiver station (BTS) in a global system for mobile communications (GSM) or a code division multiple access (CDMA) system, or may be a NodeB (NB) in a wideband code division multiple access (WCDMA) system, or may be an evolved NodeB (eNB or eNodeB) in a long term evolution (LTE) system, or may be a radio controller in a cloud radio access network (CRAN) scenario. Alternatively, the base station may be a relay station, an access point, a vehicle-mounted device, a wearable device, a gNodeB (gNB) in a new radio (NR) system, a base station in a future evolved network, or the like. This is not limited in embodiments of this disclosure.

As shown in FIG. 2, a base station provided in embodiments of this disclosure includes a base station antenna feed system. During actual use, the base station antenna feed system mainly includes an antenna 10, a feeder line 02, a grounding apparatus 03, and the like. The antenna 10 is generally fastened on a holding pole 04, and a downtilt of the antenna 10 may be adjusted by adjusting a mounting bracket 05 through the antenna, to adjust signal coverage of the antenna 10 to some extent.

In addition, the base station may further include a radio frequency processing unit 06 and a baseband processing unit 20. For example, the radio frequency processing unit 06 may be configured to: perform frequency selection, amplification, and down-conversion processing on a signal received by the antenna 10, convert the signal into an intermediate frequency signal or a baseband signal, and send the intermediate frequency signal or the baseband signal to the baseband processing unit 20. Alternatively, the radio frequency processing unit 06 is configured to: perform up-conversion and amplification processing on an intermediate frequency signal sent by the baseband processing unit 20, convert the intermediate frequency signal into a radio signal through the antenna 10, and send the radio signal. The baseband processing unit 20 may be connected to a feed network of the antenna 10 through the radio frequency processing unit 06. In some implementations, the radio frequency processing unit 06 may also be referred to as a remote radio unit (RRU), and the baseband processing unit 20 may also be referred to as a baseband unit (BBU).

As shown in FIG. 2, in a possible embodiment, the radio frequency processing unit 06 may be integrated with the antenna 10, the baseband processing unit 20 is located at a remote end of the antenna 10, and the radio frequency processing unit 06 may be connected to the baseband processing unit 20 through the feeder line 02. In another embodiment, both the radio frequency processing unit 06 and the baseband processing unit 20 may be located at a remote end of the antenna 10.

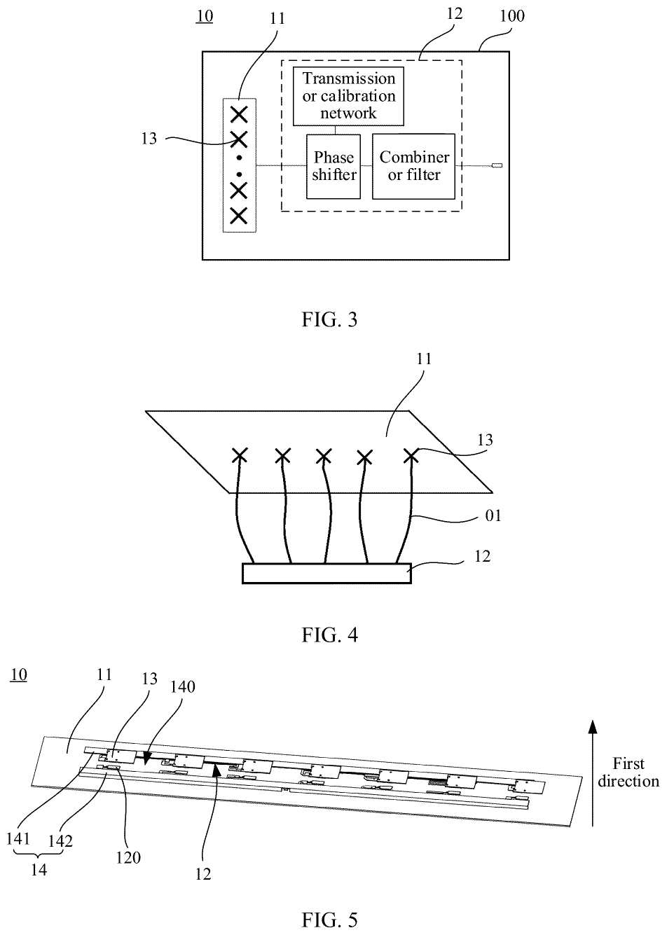

Refer to FIG. 2 and FIG. 3. The antenna 10 used in the base station may further include a radome 100, and a reflective plate 11 and a feed network 12 that are located in the radome 100. The reflective plate 11 may also be referred to as a base plate. Amain function of the feed network 12 is to feed a signal to a radiating element 13 based on a specific amplitude and phase, or send a radio signal received by the radiating element 13 to the baseband processing unit 20 of the base station based on the specific amplitude and phase. It may be understood that, during specific implementation, the feed network 12 may include at least one of components: a phase shifter, a combiner, a transmission or calibration network, a filter, or the like. Components and types of the feed network 12 and functions that can be implemented by the feed network 12 are not limited in this disclosure.

Certainly, the antenna 10 may be further used in a plurality of other types of communication devices. An example scenario of the antenna 10 is not limited in this disclosure.

For the radome 100, in terms of electrical performance, the radome 100 has good electromagnetic wave penetrability, so that normal sending and receiving of an electromagnetic signal between the radiating element 13 and the outside are not affected. In terms of mechanical performance, the radome 100 has good force-bearing performance and antioxidation performance, so that the radome 100 can withstand corrosion in an external harsh environment.

The radiating element 13 may also be referred to as an antenna element, and is a unit that forms a basic structure of the antenna. The radiating element 13 can effectively transmit or receive an electromagnetic wave. A plurality of radiating elements 13 may form an array for use. In specific examples, the antenna element may be classified into a single-polarization type, a dual-polarization type, and the like. During specific configuration, a type of the antenna element may be properly selected based on an actual requirement.

As shown in FIG. 4, the reflective plate 11 generally has a reflective surface (for example, an upper surface in the figure) and a back surface (for example, a lower surface in the figure).

In some current antennas, the radiating element 13 is usually installed on one side of the reflective surface of the reflective plate 11, the feed network 12 is installed on one side of the back surface, and feeding is performed between the feed network 12 and the radiating element 13 through a cable 01 (for example, a coaxial cable), so that the feed network 12 feeds a signal to the radiating element 13 based on a specific amplitude and phase. Disposing of the cable 01 increases material costs and a weight of the antenna 10, but also needs to install and be connected to the cable 01. Consequently, assembly time is increased, and manufacturing efficiency is reduced. In addition, when the cable 01 is connected to the radiating element 13 and the feed network 12, a manner such as a solder connection or a screw connection is usually used. In this connection manner, a network insertion loss is introduced. Consequently, this is not conducive to ensuring working performance of the antenna 10. In addition, when the antenna 10 includes a plurality of radiating elements 13, a potential risk of passive intermodulation is also increased.

Therefore, an embodiment of this disclosure provides an antenna that can reduce material usage and an overall weight, and is conducive to improving performance.

To make the objectives, technical solutions, and advantages of this disclosure clearer, the following further describes examples in detail with reference to the accompanying drawings and specific embodiments.

Terms used in the following embodiments are merely intended to describe specific embodiments, but are not intended to limit this disclosure. Terms “one”, “a”, and “this” of singular forms used in this specification and the appended claims of this disclosure are also intended to include a form such as “one or more”, unless otherwise specified in the context clearly. It may be further understood that, in the following embodiments of this disclosure, “at least one” means one, two, or more.

Reference to “an embodiment” or the like described in this specification means that one or more embodiments of this disclosure include a particular feature, structure, or characteristic described with reference to embodiments. Therefore, in this specification, statements, such as “in an embodiment”, “in some implementations”, and “in other implementations”, that appear at different places do not necessarily mean referring to a same embodiment. Instead, the statements mean referring to “one or more but not all of embodiments”, unless otherwise specifically emphasized in other ways. Terms “include”, “have”, and variants of the terms all mean “include but are not limited to”, unless otherwise specifically emphasized in other ways.

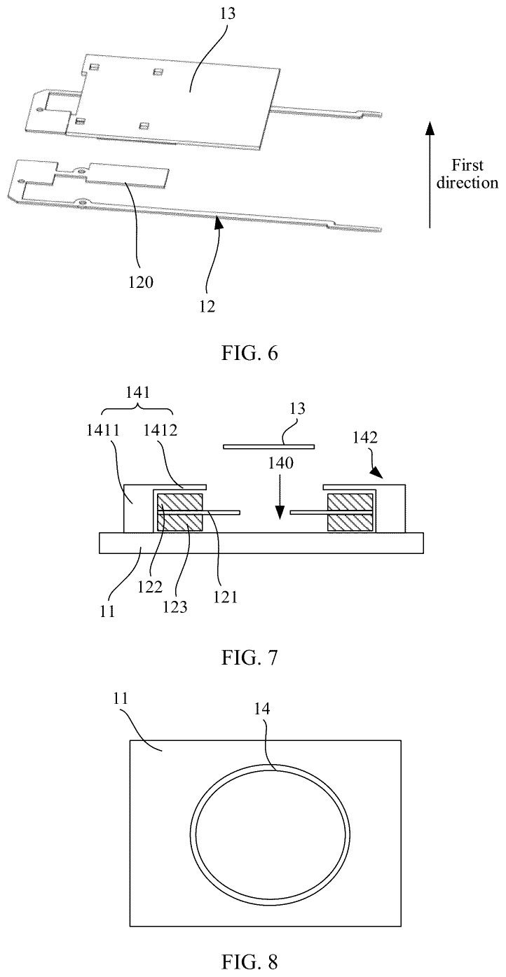

As shown in FIG. 5 and FIG. 6, in an embodiment provided in this disclosure, the antenna 10 may include the reflective plate 11, a mounting bracket 14, the feed network 12, and the radiating element 13. The reflective plate 11 has the reflective surface (the upper surface in the figure). The mounting bracket 14 is disposed on one side of the reflective surface, and the mounting bracket 14 and the reflective surface form a cavity 140 facing toward an exposure in a first direction. The feed network 12 is disposed in the cavity 140. The feed network 12 has a feed point 120, and a projection of the feed point 120 is located in the exposure. The radiating element 13 is also disposed on the side of the reflective surface. A projection of the radiating element 13 on the mounting bracket 14 is located in the exposure, and the radiating element 13 is coupled to the feed point 120. In the antenna 10 provided in this disclosure, both the feed network 12 and the radiating element 13 are disposed on the side of the reflective surface of the reflective plate 11, so that feeding can be performed between the feed network 12 and the radiating element 13 in a coupling manner. In addition, the mounting bracket 14 and the reflective surface may jointly form the cavity 140 having the exposure (or a semi-open exposure), to provide accommodation space for the feed network 12. Both the projection of the feed point 120 of the feed network 12 and the projection of the radiating element 13 are located in the exposure, so that coupling between the feed network 12 and the radiating element 13 may be implemented. Alternatively, it may be understood that, in the antenna 10 provided in this disclosure, the feed network 12 and the radiating element 13 are disposed on a same side of the reflective surface of the reflective plate 11. Therefore, the feed network 12 may feed the radiating element 13 in a coupling manner, to avoid using an additional cable. Therefore, material usage and an overall weight of the antenna 10 can be reduced. In addition, because the cable is omitted, or the feed network 12 and the radiating element 13 are coupled for feeding, a connection manner such as a solder connection, a screw connection, or a rivet connection may be avoided, so that introduction of an additional network loss can be avoided, and deterioration of passive intermodulation can be avoided. This is conducive to improving communication quality of the antenna 10.

It should be noted that, that the projection of the feed point 120 is located in the exposure means that the feed point 120 may be located in the cavity 140, and the projection of the feed point 120 is located in the exposure. Alternatively, the feed point 120 may extend out of the cavity 140 through the exposure, and the projection of the feed point 120 is located in the exposure. That the projection of the radiating element 13 is located in the exposure means that at least a part of the projection of the radiating element 13 is located in the exposure. Alternatively, the entire projection of the radiating element 13 is located in the exposure. Alternatively, it may be understood that the radiating elements 13 may be stacked on an outer side of the exposure. For example, the radiating element 13 may be fastened on the reflective plate 11 and disposed right above the exposure.

When the feed point 120 is disposed, sizes of the projections of the feed point 120 and the radiating element 13 may be greater than or equal to ⅛ of an operating wavelength of the radiating element 13, and are less than or equal to ½ of the operating wavelength of the radiating element 13, so that the feed point 120 can effectively feed the radiating element 13. The operating wavelength of the radiating element 13 is a wavelength of an electromagnetic wave generated by the radiating element 13.

Passive intermodulation (PIM) is also referred to as passive cross-modulation, intermodulation distortion, and the like, and means that when two or more signals at different frequencies are mixed together in a non-linear device, a spurious signal is generated. When the spurious signal falls within a receive frequency band of the radiating element 13, interference is caused to signal receiving, and system communication quality is reduced. Factors that cause passive intermodulation are complex. For example, passive intermodulation may occur at a connection point or interface of any two different metals, for example, a solder joint, a connection joint between solder and a cable or another conductive structure, or a connection joint between a screw and a cable. Therefore, when the foregoing connection manner such as the solder connection, the screw connection, or the rivet connection is used in the antenna 10, passive intermodulation is inevitably caused, thereby affecting communication quality of the antenna 10.

Therefore, in this embodiment provided in this disclosure, feeding is performed between the feed network 12 and the radiating element 13 in a coupling manner, so that feeding between the feed network 12 and the radiating element 13 can be effectively avoided in a manner of using a cable, solder, or a connecting piece (for example, a screw). In this way, material usage of the antenna 10 can be effectively reduced, and zero soldering can be implemented. This is conducive to ensuring communication quality of the antenna 10.

In addition, in the antenna 10 provided in this disclosure, because the feed network 12 is disposed on the reflective surface of the reflective plate 11, more components for implementing other functions may be disposed on a back surface of the reflective plate 11. This is conducive to improving functionality and function density of the antenna 10.

As shown in FIG. 5, in some implementations, the mounting bracket 14 may be made of a conductive material, to perform electromagnetic shielding on the feed network 12, to prevent an interference signal generated by the feed network 12 from affecting the radiating element 13. This is conducive to ensuring normal working performance of the radiating element 13. During specific implementation, the mounting bracket 14 may be made of a conductive material such as aluminum or copper. Alternatively, in another implementation, the mounting bracket 14 may alternatively be prepared by using an insulated material such as polyimide or nylon, so that material costs of the mounting bracket 14 can be effectively reduced. Alternatively, the mounting bracket 14 may be made of a material with low density, to reduce a weight. Finally, a layer of conductive material may be made on a surface of the mounting bracket 14, to improve electromagnetic shielding performance. The conductive material formed on the surface of the mounting bracket 14 may be made in a manner of chemical vapor deposition, electroplating, or the like. A specific material and a preparation process of the conductive material formed on the surface of the mounting bracket 14 are not limited in this disclosure.

In some implementations, the mounting bracket 14 and the reflective plate 11 may be fixedly connected through a conductive connecting piece, or may be fixedly connected through an insulated connecting piece.

In a possible implementation, the mounting bracket 14 and the reflective plate 11 may be fixedly connected through the connecting piece such as a screw or a rivet made of a metal material. Alternatively, a fixed connection and an electrical connection may be implemented between the mounting bracket 14 and the reflective plate 11 in a soldering manner. Alternatively, it may be understood that, through the conductive connecting piece, the fixed connection between the mounting bracket 14 and the reflective plate 11 may be implemented, but also the conductive connection between the mounting bracket 14 and the reflective plate 11 may be implemented, so that the mounting bracket 14 can be grounded through the reflective plate 11.

In another possible implementation, the mounting bracket 14 and the reflective plate 11 may be fixedly connected through the connecting piece such as a screw made of an insulated material: nylon, polyimide, or the like. Alternatively, the mounting bracket 14 may be fixedly connected to the reflective plate in a bonding manner. Alternatively, it may be understood that, the fixed connection between the mounting bracket 14 and the reflective plate 11 may be implemented by using a material with a light weight, to reduce the overall weight of the antenna 10.

In addition, the electrical connection between the mounting bracket 14 and the reflective plate 11 may be implemented in a coupling manner. Alternatively, the mounting bracket 14 may be connected to the reflective plate 11 through a separate cable, to implement grounding of the mounting bracket 14. Alternatively, when the mounting bracket 14 is connected to the reflective plate 11 through a plurality of connecting pieces, at least one conductive connecting piece may be used, so that the electrical connection between the mounting bracket 14 and the reflective plate 11 may be implemented.

When the mounting bracket 14 is disposed, shapes and structures of the mounting bracket 14 may be diversified. For example, as shown in FIG. 5, in an embodiment provided in this disclosure, the mounting bracket 14 includes two frame bodies: a first frame body 141 and a second frame body 142.

Specifically, both the first frame body 141 and the second frame body 142 may be of a long strip structure. The first frame body 141 and the second frame body 142 are disposed in parallel with each other, and the first frame body 141, the second frame body 142, and the reflective surface jointly form the cavity 140. A gap (or a distance) between the first frame body 141 and the second frame body 142 forms the exposure.

During specific implementation, shapes of the first frame body 141 may diversified. For example, as shown in FIG. 7, the first frame body 141 is used as an example. A cross-sectional shape of the first frame body 141 is approximately L-shaped. Specifically, the shape includes a vertical segment 1411 and a horizontal segment 1412. One end (a lower end in the figure) of the vertical segment is disposed toward the reflective surface, there is a gap between the horizontal segment and the reflective surface, and the gap may form a part of the cavity 140.

For the second frame body 142, in this embodiment provided in this disclosure, the first frame body 141 and the second frame body 142 may be of approximately a same structure, and the first frame body 141 and the second frame body 142 are disposed in a mirror-symmetric manner.

It may be understood that, during specific implementation, the distance between the first frame body 141 and the second frame body 142 may be flexibly adjusted based on an actual requirement, so that sizes of the cavity 140 and the exposure may be changed. Alternatively, in some implementations, the first frame body 141 and the second frame body 142 may be disposed at an included angle, instead of being disposed in parallel. In some implementations, the mounting bracket 14 may also include more frame bodies. Alternatively, it may be understood that the cavity 140 may also be formed by more frame bodies. In some other implementations, the mounting bracket 14 may alternatively be of a monolithic structure.

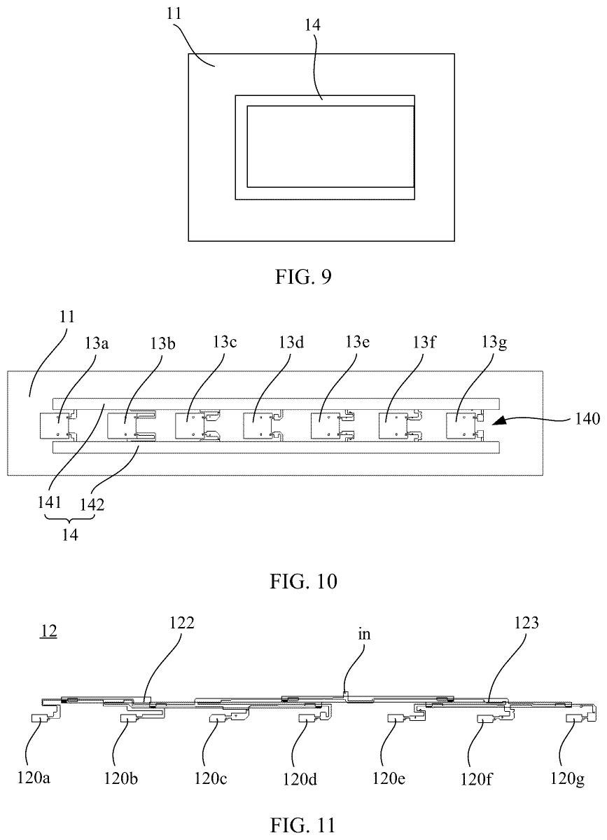

For example, as shown in FIG. 8, the mounting bracket 14 may be of a ring structure. A cross section of the mounting bracket 14 may be in an L shape shown in FIG. 7, or may be in another shape. A cross-sectional shape of the mounting bracket 14 is not limited in this disclosure. Alternatively, the mounting bracket 14 may be of a U-shaped structure shown in FIG. 9. Alternatively, the mounting bracket 14 may be of a rectangular frame structure. For example, based on the U-shaped structure shown in FIG. 9, a right side may be disposed in a closed shape, to form the rectangular frame structure. Certainly, in another implementation, the mounting bracket 14 may alternatively be of another shape structure. This is not limited in this disclosure.

It may be understood that, during specific implementation, the mounting bracket 14 may separately form a structure of the cavity 140 having the exposure. Alternatively, the mounting bracket 14 and the reflective surface of the reflective plate 11 may jointly form a structure of the cavity 140 structure having the exposure. A specific shape and structure of the mounting bracket 14 and a quantity of used mounting brackets 14 are not limited in this disclosure.

During specific implementation, the feed network 12 may include a phase shifter, a combiner, a filter, a transmission or calibration network, or the like. As shown in FIG. 7, the feed network 12 may include a suspended strip 121 used to transmit an electromagnetic wave. The suspended strip 121 is an electromagnetic wave transmission line, and a transmission mode of the suspended strip 121 is approximately the same as that of a coaxial cable, and is a TEM wave. In terms of structure, the suspended strip 121 is mainly formed by an inner conductor and a ground cable disposed on an upper layer and a lower layer of the inner conductor. The electromagnetic wave is distributed between the upper layer and the lower layer of the inner conductor, and propagates along an axis (or a length direction of the suspended strip 121).

In this embodiment provided in this disclosure, the suspended strip 121 may be suspended in the cavity 140. That is, there is a distance between the suspended strip 121 and an inner wall of the cavity 140, so that the suspended strip 121 is disposed in the cavity 140 in a suspended shape, and the suspended strip 121 is prevented from being in conductive contact with the mounting bracket 14. It may be understood that, during specific implementation, the suspended strip 121 may alternatively be fastened in the cavity 140 by using another auxiliary structure (for example, an insulated support column). This is not limited in this disclosure.

In addition, as shown in FIG. 7 and FIG. 11, in this embodiment provided in this disclosure, the feed network 12 may have a phase shifter. Specifically, the phase shifter is a dielectric phase shifter. Specifically, the phase shifter may include a first sliding medium 122 and a second sliding medium 123. The first sliding medium 122 is disposed on an upper side of the suspended strip 121, and the first sliding medium 122 can slide relative to the suspended strip 121. The second sliding medium 123 is disposed on an lower side of the suspended strip 121, and the first sliding medium 122 can slide relative to the suspended strip 121. When the first sliding medium 122 and the second sliding medium 123 slide to different positions of the suspended strip 121, phases of the electromagnetic wave in the suspended strip 121 may be adjusted to different degrees. During specific implementation, relative positions of the first sliding medium 122 and the second sliding medium 123 may be properly adjusted based on an actual requirement, to adjust the phases of the electromagnetic wave.

It may be understood that, during specific implementation, the phase shifter may use a currently commonly used adjustable type. Certainly, the phase shifter may alternatively use an unadjustable type. Details are not described herein.

In addition, during actual implementation, the antenna 10 may include a plurality of radiating elements 13. For example, as shown in FIG. 10, in this embodiment provided in this disclosure, the antenna 10 includes seven radiating elements: a radiating element 13a, a radiating element 13b, a radiating element 13c, a radiating element 13d, a radiating element 13e, a radiating element 13f, and a radiating element 13g. Working frequencies of the seven radiating elements may be the same or may be different.

In addition, to feed each radiating element, the feed network 12 is divided into two parts. One part is located below a first mounting bracket 14, and the other part is located below a second mounting bracket 14. Each part has seven feed points, configured to feed a corresponding radiating element 13. The part located below the first mounting bracket 14 is used as an example. The seven feed points are a feed point 120a, a feed point 120b, a feed point 120c, a feed point 120d, a feed point 120e, a feed point 120f, and a feed point 120g, and each feed point is configured to feed a corresponding radiating element. For example, the feed point 120a is configured to feed the radiating element 13a, and the feed point 120b is configured to feed the radiating element 13b. The feed network 12 may include a feed strip, and one end of the feed strip may extend out of the exposure. The feed point 120 may be located at the end that is of the feed strip and that extends out of the exposure. During specific implementation, the feed strip may be a microstrip or the like. A specific type of the feed strip is not limited in this disclosure.

During actual implementation, a signal may be input into the feed network 12 through an in port, and is coupled and fed to a corresponding radiating element through seven feed points, and finally radiated through the radiating element. It may be understood that, during specific implementation, the in port may be located in the cavity 140, or may be located outside the cavity 140. In addition, the feed network 12 may further include a power divider, to adjust radiated power of different radiating elements. A quantity and a type of power dividers are not limited in this disclosure. Certainly, in another implementation, the feed network 12 may further include another functional component. Details are not described herein.

The foregoing descriptions are merely specific implementations of this disclosure, but are not intended to limit the protection scope of this disclosure. Any variation or replacement readily figured out by a person skilled in the art within the technical scope disclosed in this disclosure shall fall within the protection scope of this disclosure. Therefore, the protection scope of this disclosure shall be subject to the protection scope of the claims.

What is claimed is:

1. An antenna, comprising:
a reflective plate, having a reflective surface;
a mounting bracket, wherein the mounting bracket is disposed on one side of the reflective surface, and the mounting bracket and the reflective surface form a cavity facing toward a first direction;
a feed network, disposed in the cavity, wherein the feed network has a feed point, and a projection of the feed point is located in the cavity; and
a radiating element, disposed on the one side of the reflective surface, wherein
a projection of the radiating element on the mounting bracket is located in the cavity, and the radiating element is coupled to the feed point.

2. The antenna according to claim 1, wherein the feed network is fixedly connected to the mounting bracket.

3. The antenna according to claim 1, wherein the radiating element is positioned outside of the cavity.

4. The antenna according to claim 1, wherein a size of the projection of the feed point and a size of the projection of the radiating element are both greater than or equal to ⅛ of an operating wavelength of the radiating element, and are both less than or equal to ½ of the operating wavelength of the radiating element.

5. The antenna according to claim 1, wherein the feed network comprises a feed strip, and an end of the feed strip extends out of the cavity; and
the feed point is located at the end of the feed strip.

6. The antenna according to claim 1, wherein the mounting bracket is made of a conductive material.

7. The antenna according to claim 1, wherein the mounting bracket comprises a first frame body and a second frame body;
the first frame body and the second frame body are disposed in parallel with a gap in between them;
the first frame body, the second frame body, and the reflective surface form the cavity; and
the gap between the first frame body and the second frame body forms an exposure.

8. The antenna according to claim 1, wherein the antenna comprises a plurality of radiating elements; and
the antenna comprises a plurality of feed points, and each radiating element is coupled to a corresponding feed point.

9. The antenna according to claim 1, wherein the feed network further comprises a suspended strip, the suspended strip is disposed in the cavity, and there is a gap between the suspended strip and an inner wall of the cavity.

10. The antenna according to claim 9, wherein the feed network further comprises a dielectric phase shifter; and
the dielectric phase shifter comprises a first sliding medium and a second sliding medium, and the first sliding medium and the second sliding medium are disposed on two sides of the suspended strip, and are slidably connected to the suspended strip.

11. The antenna according to claim 1, wherein the mounting bracket is fixedly connected to the reflective plate through a conductive connecting piece.

12. The antenna according to claim 1, wherein the mounting bracket is fixedly connected to the reflective plate through an insulated connecting piece.

13. The antenna according to claim 1, wherein the antenna further comprises a radome, and the reflective plate, the mounting bracket, the feed network, and the radiating element are located in the radome.

14. A communication device comprising the antenna of claim 1.

15. The communication device according to claim 14, wherein the feed network is fixedly connected to the mounting bracket.

16. The communication device according to claim 14, wherein the radiating element is positioned outside of the cavity.

17. The communication device according to claim 14, wherein a size of the projection of the feed point and a size of the projection of the radiating element are both greater than or equal to ⅛ of an operating wavelength of the radiating element, and are both less than or equal to ½ of the operating wavelength of the radiating element.

18. The communication device according to claim 14, wherein the feed network comprises a feed strip, and an end of the feed strip extends out of the exposure; and
the feed point is located at the end of the feed strip.

19. The communication device according to claim 14, wherein the mounting bracket is made of a conductive material.

20. The communication device according to claim 14, wherein the mounting bracket comprises a first frame body and a second frame body;
the first frame body and the second frame body are disposed in parallel with a gap in between them;
the first frame body, the second frame body, and the reflective surface form the cavity; and
the gap between the first frame body and the second frame body forms an exposure.
